(19) United States
(12) Patent Application Publication
(10) Pub. No.: US 2010/0132235 A1
(43) Pub. Date: Jun. 3, 2010

(54) Sign Connector

(76) Inventors: John Sarro, Kennett Square, PA (US); Penny Sarro, Kennett Square, PA (US); Robert Waters, West Chester, PA (US); Joseph Waters, West Chester, PA (US)

Correspondence Address: FISH & RICHARDSON P.C., P.O. BOX 1022, MINNEAPOLIS, MN, 55440-1022, US

(21) Appl. No.: 12/327,382

(22) Filed: Dec. 3, 2008

(51) Int. Cl. G09F 15/00

(52) U.S. Cl. 40/606.01; 40/607.13

(57) ABSTRACT

In one general aspect, a sign connector is provided. The sign connector including: a first bracket connected to a first sign, the first bracket including a receiving means; and a second bracket including a first and second member, an end of the first member attached to an end of the second member to form an angle between the first member and the second member, and the first member is detachably connected to a second sign and the second member is adapted to be received within the receiving means of the first bracket.

### FIELD

The present disclosure relates to the field of connectors, and in particular, to a connector for fastening two signs together.

### BACKGROUND

Displays, such as signs, are an effective way of conveying information. Typically, an advertiser or promoter may erect a sign to convey information regarding a product or service that is offered. For example, a shopping center may feature a sign advertising the amount of space that is available in the shopping center.

While signs are an effective form of advertisement, there are drawbacks associated with signs. One such drawback is that the information displayed on the sign is stagnant and may not be easily customizable after the sign is created. For example, the price or availability of a product or service may change, an advertiser may wish to update the sign to reflect current events such as the season, or a national advertiser may wish to modify the sign to account for the regional interests or tastes of a particular market.

Current solutions to the above mentioned drawback include the use of signs with changeable elements. For example, the shopping center sign described above may feature a removable element listing the available space in the shopping center. However, these changeable elements are typically connected using specialized tools or instruments. Thus, where a change is needed to be made to a sign, a sign technician, or other professional, must be sent to change the sign, resulting in an expense. Further, any delay caused by the unavailability of the sign professional may result in inaccurate information being displayed on the sign resulting in potential lost revenue for the sign operator.

### SUMMARY

In one general aspect, a sign connector is provided. The sign connector including: a first bracket connected to a first sign, the first bracket including a receiving means; and a second bracket including a first and second member, an end of the first member attached to an end of the second member to form an angle between the first member and the second member, and the first member is detachably connected to a second sign and the second member is adapted to be received within the receiving means of the first bracket.

Implementations may include one or more of the following features. The sign connector may further include a securing means adapted to secure the second member within the receiving means. The securing means may further include a bolt that secures the second member in the securing mean by passing through the receiving mean and the second member while the second member is within the receiving means. The securing means may further include a security means. The angle may be 90 degrees. The first bracket may be permanently connected to the first sign. The first sign may be a box sign. The second sign may be a sign element. The first member may be detachably connected to a second sign by a clevis pin. The end of the first member may be attached to the end of the second member by a hinge.

The details of one or more implementations of the sign connector are set forth in the accompanying drawings and the description below. Other features, objects, and advantages of the sign connector will be apparent from the description and drawings, and from the claims.

### DESCRIPTION OF DRAWINGS

The invention is illustrated in the figures of the accompanying drawings, which are meant to be exemplary and not limiting, and in which like references are intended to refer to like or corresponding parts.

FIG. 1 is an illustration of an example first bracket of a sign connector and a first sign;

FIGS. 2a and 2b are more detailed illustrations of an example first bracket;

FIG. 3 is an illustration of an example second bracket of a sign connector and a second sign;

FIGS. 4 and 5 are more detailed illustrations of an example first bracket and second bracket of a sign connector;

FIG. 6 is an illustration of a sign connector including a security means;

FIG. 7 is an illustration of a first bracket adapted to receive multiple second brackets; and

FIG. 8 is an illustration of an example method for connecting a first sign to a second sign.

Like reference symbols in the various drawings indicate like elements.

### DETAILED DESCRIPTION

A connector for connecting two signs is disclosed. The connector provides for the connection of a first sign to a second sign. In some implementations, the first sign may be a permanent sign and the second sign may be a temporary sign element. For example, the first sign may be a permanent sign for a shopping mall and the second sign may be a temporary seasonal decoration such as a pumpkin, Christmas tree, or American flag. The connector may allow the second sign to be connected to, and removed from, the first sign without the use of complicated tools or equipment.

In one implementation, the connector includes two brackets. A first bracket is connected to the first sign, and a second bracket is detachably connected to the second sign. The second bracket is adapted to be received by a gap in the first bracket and secured into place by a sliding bolt or other securing means, temporarily attaching the second sign to the first sign. The second sign may then be removed from the first sign by removing the sliding bolt or other securing means. Particular implementations of the connector are described below in more detail with respect to the figures.

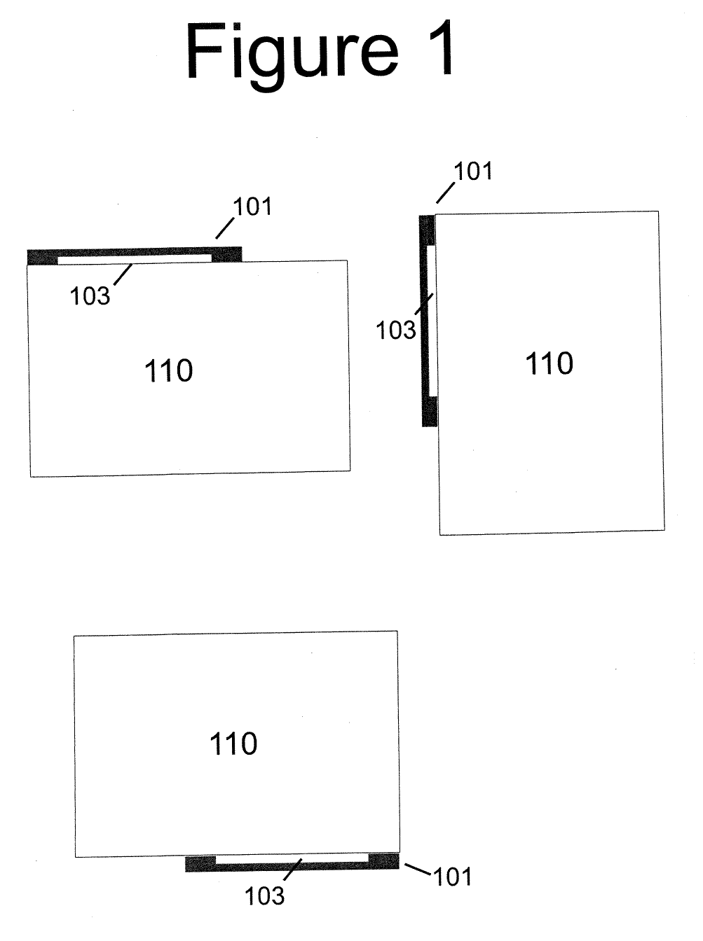

FIG. 1 is an illustration of an example first bracket 101 of a sign connector. The first bracket 101 of the sign connector is adapted to be attached to a permanent or semi-permanent sign 110. The first bracket 101 may connect to the sign 110 at a variety of placements. As illustrated, the first bracket 101 may connect to the top, bottom, or side of a sign 110. Other sign 110 placements may also be used by the first bracket 101.

In some implementations, the sign 110 is a “box sign.” A box sign may be a multi-faceted prism (e.g., a cuboid) with a message or advertisement on one or more of the faces. The bracket 101 may be connected to any of the faces of the box sign.

In some implementations, the first bracket 101 may be connected to the sign 110 as to form a slot or gap 103. The slot 103 may be adapted to receive a second bracket of the sign connector. As illustrated, the gap 103 may be defined by the space between the first bracket 101 and the sign 110. In other implementations, the gap 103 may be defined within the first bracket 101.

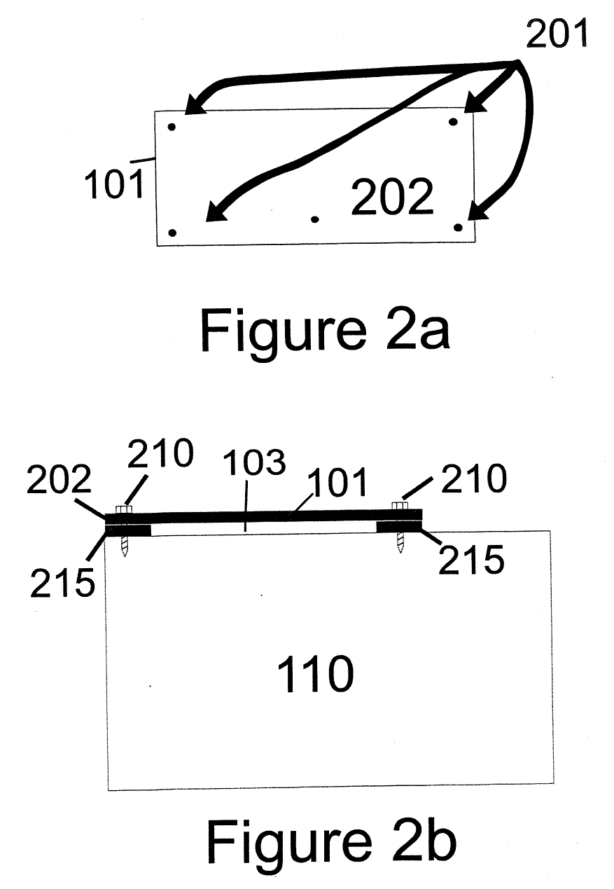

FIGS. 2a and 2b are more detailed illustrations of the first bracket 101. The first bracket 101 may include a base portion 202 that is approximately three inches wide, seven inches long and one quarter inch thick. Other dimensions may also be used for the first bracket 101. The base portion 202 may be constructed by a ridged material such as metal, plastic, or wood. Any rigid material known in the art may be used.

The gap 103 of the first bracket 101 may be defined by the attachment of feet 215 between the sign 110 and the base portion 202. In some implementations the feet 215 may be approximately one quarter of an inch thick, resulting in a gap 103 that is one quarter of an inch in height. Other thicknesses may also be used. In some implementations, the feet 215 may be separate from the base portion 202 and attached to the base portion 202 by one of any attachment means known in the art such as welds, screws, or an adhesive. In other implementations, the feet 215 may be part of the base portion 202 and formed by bending, or otherwise manipulating, the base portion 202, for example.

As illustrated the first bracket 101 may include a plurality of screw holes 201. The screw holes 201 may be pre-drilled during the manufacturing of the first bracket 101 to allow the first bracket 101 to be easily attached to the sign 110, for example. In the example shown, the screw holes 201 extend through the base portion 202 through the feet 215. While four screw holes 201 are illustrated in FIG. 2a, it is for illustrative purposes only, more or fewer screw holes 201 may be used in the first bracket 101.

The first bracket 101 may be connected to the sign 110 by screws 210 inserted through the screw holes 201. However, a variety of connection means may also be used to connect the first bracket 101 to the sign 110 such as, for example, magnets, nails, and adhesives.

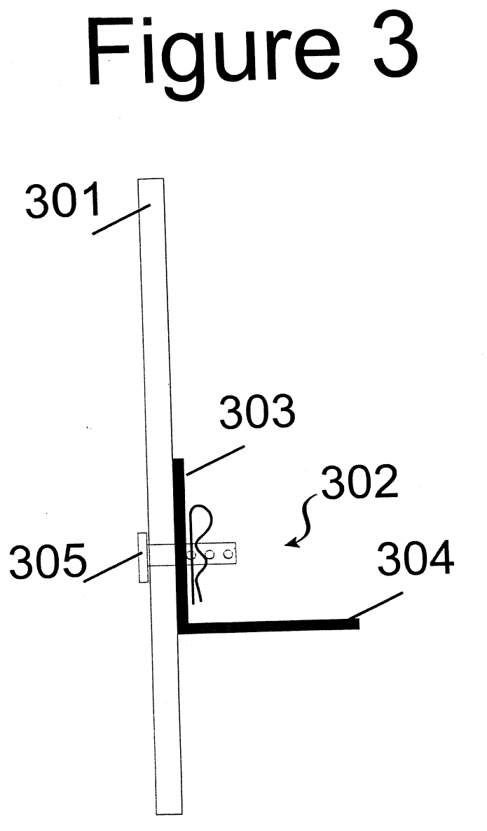

FIG. 3 is an illustration of an example second bracket 302 of a sign connector and a second sign 301. The second bracket 302 may be connected to the second sign 301 and allow the second sign 301 to be temporarily attached to the first sign 101. In some implementations, the second bracket has two members, a first member 303 and a second member 304. The first and second members may be constructed from any rigid material known in the art including but not limited to, metal, plastic, or wood, for example.

In some implementations, the first member 303 is adapted to detachably connect to the second sign 301. As illustrated, the first member 303 is attached to the second sign 301 using a clevis pin 305 inserted through a hole in the second sign 301. Other detachable connection means may also be used to attach the second sign 301 to the first member 303 such as magnets, adhesives, or screws, for example. Alternatively, the first member 303 may be permanently connected to the sign 301 by welding or other form of permanent attachment method. While the first member 303 is shown attached to the middle of the second sign 301, this is for illustrative purposes only. The first member 303 can be attached to the sign 301 in a variety positions and placements including the bottom, top, and sides of the sign 301.

The first member 303 is connected to the second member 304. In some implementations, the first member 303 and second member 304 may be part of the same piece of material such as a piece of metal, for example. In other implementations, the first member 303 and the second member 304 may be separate pieces of material and connected together through a weld or other connection means. The first member 303 and the second member 304 may be connected at approximately a 90 degree angle, however, other angles may also be used such as 45 degrees, 75 degrees, and so forth.

In some implementations, the first member 303 and the second member 304 are connected by a hinge, joint, or other connection means that allows movement of the members 303 and 304 with respect to one another. By connecting the second member 304 to the first member 303 with a hinge, the protrusion of the second bracket 302 from the second sign 301 may be minimized when the second sign 301 is not connected to the first sign 110. For example, the second member 304 may be folded to lie parallel to the second sign 301. In addition, the viewing angle of the second sign 301 maybe adjusted when connected to the first sign 110 using the hinge.

The second member 304 may be of a height that is suitable to be received by the gap 103 of the first bracket 101. For example, if the gap 103 has a height of one quarter of an inch, the height of the second member 304 may be slightly smaller than one quarter of an inch such that it may be easily inserted into the gap 103. The length of the second member 304 may be no longer than the length of the first bracket 101, but no shorter than the length required to sufficiently support the weight of the second sign 301 without bending or compromising the connection between the first member 303 and the second member 304. The width of the second member 304 may be similarly chosen as to not exceed the width of the gap 103 while providing sufficient lateral stability to the sign 301.

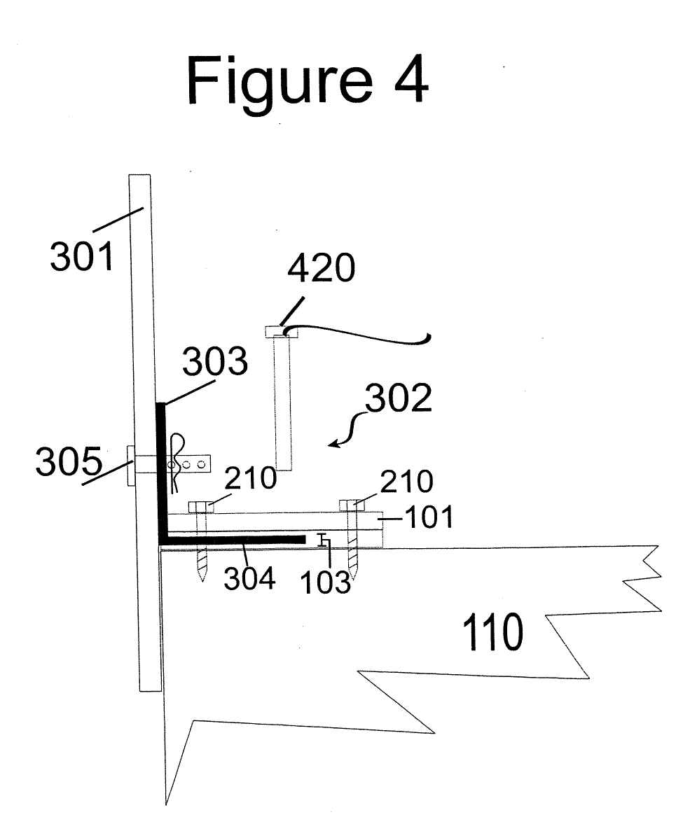

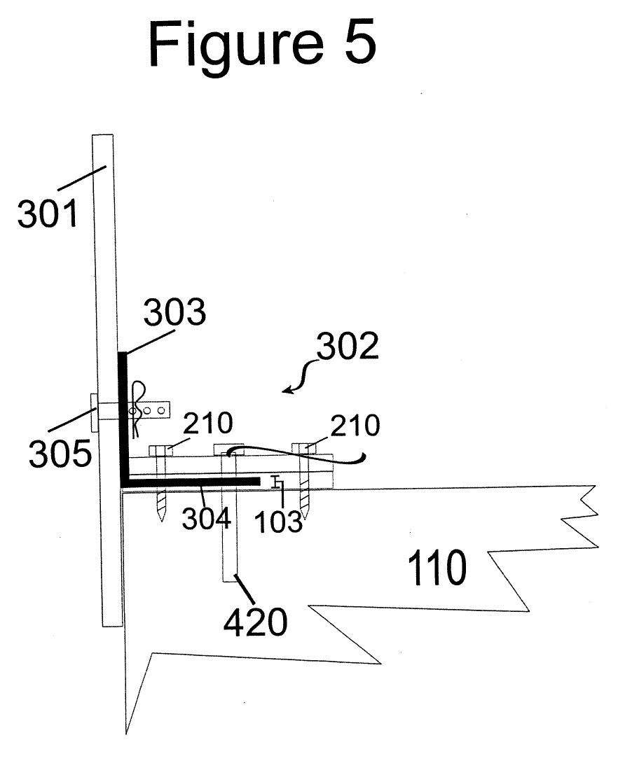

FIGS. 4 and 5 are more detailed illustrations of an example first bracket 101 and second bracket 302 of a sign connector. As illustrated, the second member 304 of the second bracket 302 may be inserted into the gap 103 of the first bracket 101. In order to secure the second member 304 of the second bracket 302 within the gap 103 of the first bracket 101, securing means may be used. In some implementations, a locking pin 420 may be used. However, any securing means known in the art may be used such as screws, bolts, adhesives, magnets, clamps, weights, and so forth.

As illustrated in FIG. 5, the locking pin 420 may secure the second member 304 of the second bracket 302 within the gap 103 of the first bracket 101 by passing through the base portion 202 of the first bracket 101, and through the second member 304. Similarly, the second member 304 may be unsecured by removing the locking pin 420 from the second member 304 and the base portion 202. Thus, the locking pin 420, the first bracket 101, and the second bracket 302 of the sign connector allows for the temporary attachment of the second sign 301 to the first sign 110 without the use of specialized tools or equipment.

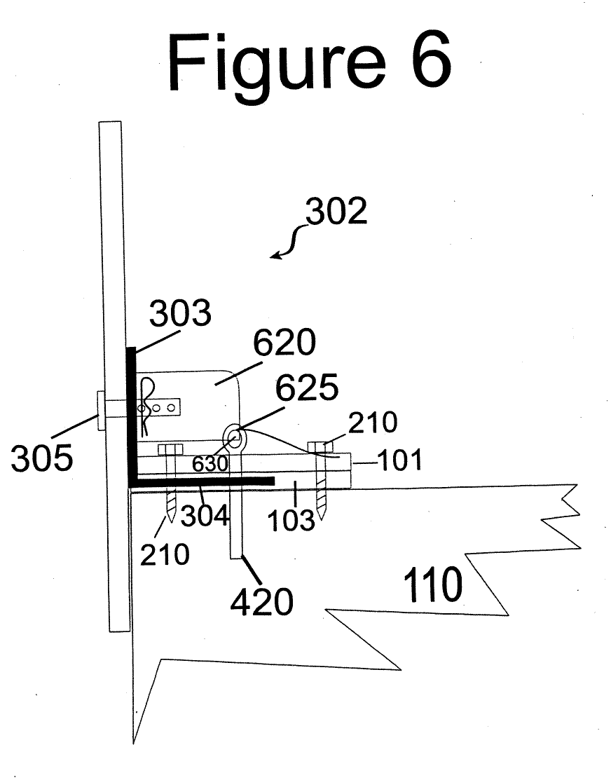

FIG. 6 is an illustration of a sign connector including a security means. In some implementations, the second bracket may include a security means 620. The security means may prevent an unauthorized party from removing the second member 304 from the gap 103 of the first bracket 101 after the locking pin 420 has been inserted.

In some implementations, the security means may be a plate 620. The plate 620 may be approximately 1.25 inches in height, 1.38 inches in length, and 0.25 inches thick. Other dimensions may also be used. As illustrated, the plate 620 may be secured to, or approximate to, the first member 303 and extend in the direction of the second member 304 to at least the location of the locking pin 420. The plate 620 may be constructed from a variety of rigid materials such as metal, wood, and plastic, for example.

The plate 620 may include a hole 630. The hole 630 may be at a location in the plate 620 such that the hole 630 is adjacent to (i.e., lines up with) a similarly sized loop 625 placed at the end of the locking pin 420.

After the second member 304 is inserted into the gap 103 of the first bracket 101 and the locking pin 420 is inserted through the base portion 202, the hole 630 and the loop 625 are desirably aligned. To prevent unauthorized users from removing the locking pin 420, a lock (not shown) may be inserted through the loop 625 and the hole 630, thus securing the locking pin 420 to the plate 620 and preventing the removal of the locking pin 420 without removing the inserted lock. The lock may include a variety of lock types known in the art including, but not limited to, a padlock, combination lock, and a u-lock, for example.

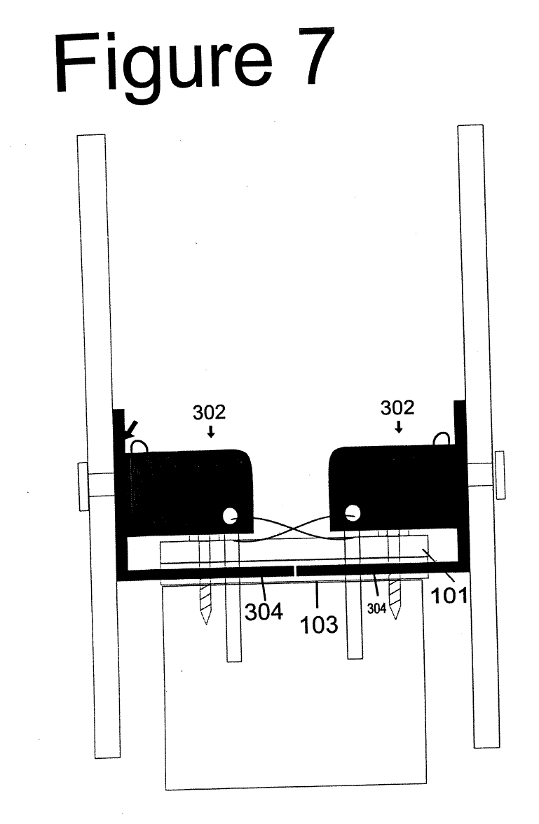

FIG. 7 is an illustration of a first bracket adapted to receive multiple second brackets. Multiple second brackets 302 may be inserted into a single first bracket 101. As illustrated, the first bracket 101 may be adapted to receive at least two second brackets 302. In order to receive two second brackets 302, the first bracket 101 may include an additional hole in the plate 202 to receive the second locking pin 420. In order to receive an additional second bracket 302, the first bracket 101 may be larger than a first bracket 101 used to receive only one second bracket 302. Alternatively, the second members 304 of the second brackets 302 may be made slightly smaller so that a normal first bracket 101 may receive the additional second bracket 302.

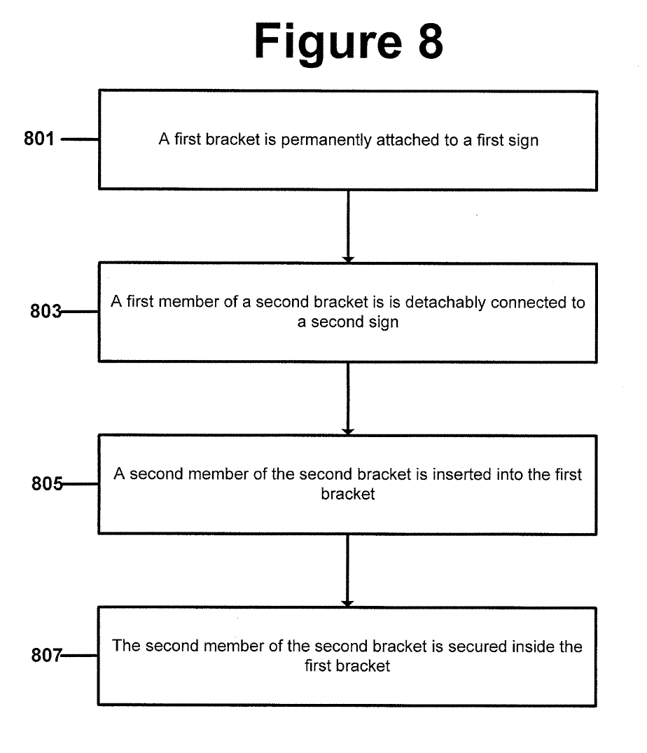

FIG. 8. is an illustration of an example method for connecting a first sign to a second sign. A first bracket is attached to a first sign (801). The first bracket may be permanently attached to the first sign by a sign professional using permanent attachment means such as screws, nails, or any other attachment means that are not easily removed. The first bracket may be similar to the first bracket 101 illustrated in FIG. 1. In some implementations, the sign is a permanent sign such as a box sign, for example.

A first member of a second bracket is detachably connected to a second sign (803). The first member of the second bracket may be attached using any one of a number of detachable connection means known in the art such as a clevis pin, magnet, and so forth. The first member of the second bracket is desirably attached in such a way that the second sign can be detached from the first sign without the use of specialized tools or devices. In some implementations, the second sign is a temporary sign or sign element. The second bracket may be similar to the second bracket 303 illustrated in FIG. 3.

A second member of the second bracket is inserted into the first bracket (805). The second member of the second bracket may be inserted into a receiving means of the first bracket such as the gap 103 illustrated in FIG. 1, for example.

The second member of the second bracket is secured inside the first bracket (807). The second member of the second bracket may be secured using a locking pin, such as the locking pin 420, inserted through the first bracket and the second member of the second bracket. Other securing means may also be used. The second member of the second bracket is desirably secured inside the first bracket in such a way that securing and unsecuring the second member can be done without the use of specialized tools of equipment.

While the sign connector has been described and illustrated in connection with particular implementations, many variations and modifications as will be evident to those skilled in this art may be made without departing from the spirit and scope of the disclosure, and the connector is thus not to be limited to the precise details of methodology or construction set forth above as such variations and modifications are intended to be included within the scope of the connector. Except to the extent necessary or inherent in the processes themselves, no particular order to steps or stages of methods or processes described in this disclosure, including the Figures, is implied. In many cases the order of process steps may be varied without changing the purpose, effect or import of the methods described.

What is claimed is:

1. A sign connector comprising:
a first bracket connected to a first sign, the first bracket comprising a receiving means; and
a second bracket comprising a first and second member, an end of the first member attached to an end of the second member to form an angle between the first member and the second member, wherein the first member is detachably connected to a second sign and the second member is adapted to be received within the receiving means of the first bracket.

2. The sign connector of claim 1, further comprising a securing means adapted to secure the second member within the receiving means.

3. The sign connector of claim 2, wherein the securing means comprises a bolt that secures the second member in the securing mean by passing through the receiving mean and the second member while the second member is within the receiving means.

4. The sign connector of claim 1, wherein the securing means further includes a security means.

5. The sign connector of claim 1, wherein the angle is 90 degrees.

6. The sign connector of claim 1, wherein the first bracket is permanently connected to the first sign.

7. The sign connector of claim 1, wherein the first sign is a box sign.

8. The sign connector of claim 1, wherein the second sign is a sign element.

9. The sign connector of claim 1, wherein the first member is detachably connected to a second sign by a clevis pin.

10. The sign connector of claim 1, wherein the end of the first member is attached to the end of the second member by a hinge.

11. A method for attaching a first sign to a second sign comprising:
permanently attaching a first bracket to a first sign;
detachably connecting a first member of a second bracket to a second sign;
inserting a second member of the second bracket inside the first bracket; and
securing the second member of the second bracket inside the first bracket.

12. The method of claim 11, wherein securing the second member of the second bracket inside the first bracket comprises inserting a locking pin through the first bracket and the second member of the second bracket.

13. The method of claim 11, wherein the first member of the second bracket is detachably connected to the second sign by a clevis pin.

14. The method of claim 11, wherein the first sign is a box sign.

15. The method of claim 11, wherein the second sign is a sign element.
